(19) United States
(12) Patent Application Publication
(10) Pub. No.: US 2010/0131236 A1
(43) Pub. Date: May 27, 2010

(54) Apparatus and Method for Measuring Deflection of a Printed Circuit Board

(75) Inventors: Francois Lafleur, Laprairie (CA); Michel Therien, Laval (CA)

Correspondence Address: JEAN-CLAUDE BOUDREAU, CRIQ BUILDING, 8475, CHRISTOPHE-COLOMB, MONTREAL, QC, H2M 2N9, CA

(73) Assignee: Centre de recherche industrielle du Quebec

(21) Appl. No.: 12/083,148

(22) PCT Filed: Oct. 5, 2006
(86) PCT No.: PCT/CA2006/001651

§ 371 Date: Apr. 4, 2008

(30) Foreign Application Priority Data
Oct. 5, 2005 (CA) 2522370

(51) Int. Cl. G06F 15/00; G01B 11/14; G01B 7/14; G01M 7/00

(52) U.S. Cl. 702/158; 73/662

(57) ABSTRACT

Deflection measuring apparatus and methods are used to prevent overstress of printed circuit boards (PCB) prior and during testing. They can be used to verify in a HALT, HASS of ESS testing protocol, if the PCB testing fixture and vibration testing setup would be likely to cause failure of PCB components during pre- testing and testing procedures, which failure would otherwise not occur with faultless components. Furthermore, In the context of a PCB to be integrated to a system as a product such as a computer, the deflection measuring apparatus and methods are used to prevent overstress of PCBs at the system assembly stage, to ensure that operations involved, such as plugging of PCB connectors, will not cause PCB components failure, which would otherwise not occur with faultless components.

### FIELD OF THE INVENTION

The present invention relates to the field of printed circuit board quality control, and more particularly to apparatus and method for measuring deflection of printed circuit board to be integrated to a system.

### BRIEF DESCRIPTION OF THE BACKGROUND ART

Product reliability testing techniques such as Environmental Stress Screening (ESS), Highly Accelerated Stress Screening (HASS) and Highly Accelerated Life Testing (HALT) have been developed to increase the service life of electrical and electronic circuits and systems integrated in products, by detecting latent flaws induced at the design or development stage. With these testing techniques, the operating and destruction limits of a given product can be identified by recreating the various types of stresses it will undergo in use, beyond product specifications and field level. Typically, an ESS process is most frequently used for testing in thermal cycle environments, with or without the use of a vibration system. Printed circuit boards in electronic systems are commonly exposed to these environments either sequentially or simultaneously for short periods of time. During such exposure or as a delayed effect thereof, latent defects of a tested printed circuit board itself or of its components can be detected and therefore repaired prior to shipping of the product to the en user, thereby resulting in improved manufacturing methods and user satisfaction.

Several vibration testing systems have been developed over the past years which have the capability of carrying on reliability testing techniques, namely electrodynamic, hydraulic or pneumatic vibration tables, and more recently, acoustical vibration system such as disclosed in U.S. Pat. No. 6,668,650 B1 issued on Dec. 13, 2003, which patent has been assigned to the present assignee since its issuance. Such acoustical testing system is provided with a baffle on which is mounted a fixture adapted to secure one or more printed circuit boards to be tested through controlled exposition to acoustical waves generated by loudspeakers provided within an enclosure integrating the baffle. Another type of test fixture is disclosed in U.S. Pat. No. 6,734,690 B1 issued on May 11, 2004 to Ashby, which addresses the problem of localized printed circuit board bending that could occur when compression connectors are interposed between integrated circuits and the PCB on which they are mounted, such bending being likely to cause electrical contact disruption, thereby disabling proper function of the IC packages. However, the test fixture disclosed in U.S. Pat. No. 6,734,690 B1 cannot reduce bending over areas of the PCB that extend beyond a specific region of interest around the particular IC package mounted thereon. Modeling-based methods for determining support location in a wireless fixture of a printed circuit assembly and for determining points of maximum deflection of a printed circuit board are disclosed in U.S. Pat. No. 6,839,883 B2 and in U.S. Pat. No. 7,103,856 B2 respectively issued on Jan. 4, 2005 and on September 2006 both to Ahrikencheikh. Such methods are based on a complex mathematical model of the fixture including its wireless PCB as well as of the PCB under test, which model involves many parameters representing the boundary and loading conditions. The practical limit inherent to that approach essentially depends on the level of reliance that the model represents the actual fixture system with sufficient accuracy.

Bending of printed circuits to be integrated in systems such as computers in their assembly stage may be also at the origin of overstress of the printed circuit boards that could cause failure thereof, thereby affecting the service life of the systems. There is still a need for a reliable instrumentation and methods designed to prevent such problem.

### SUMMARY OF INVENTION

According to the present invention, from a broad aspect, there is provided a method for measuring deflection of a printed circuit board adapted to be integrated to a system provided with a mounting structure defining a reference mounting plane. The method comprises the steps of: i) securing the printed circuit board onto the mounting structure; ii) measuring deflection of the printed circuit board in a direction substantially perpendicular to the reference mounting plane at a representative number of measurement locations on the printed circuit board; and iii) comparing the measured deflection with a predetermined limit deflection value.

According to the present invention, from a further broad aspect, there is provided an apparatus for measuring deflection of a printed circuit board adapted to be integrated to a system provided with a mounting structure defining a reference mounting plane. The apparatus comprises means for securing the printed circuit board onto the mounting structure, a displacement sensor unit for measuring deflection of the printed circuit board in a direction substantially perpendicular to the reference mounting plane at a representative number of measurement locations on the printed circuit board, and processing means for comparing the measured deflection with a predetermined limit deflection value.

According to the present invention, from another broad aspect, there is provided a system for vibration testing of a printed circuit board using the deflection measurement apparatus during pre-testing operations. The system comprises a printed circuit board mounting structure defining the reference mounting plane, a device for selectively supporting the printed circuit board at one or more selected locations on a first surface of the printed circuit board during the pre-testing operations, and a vibrator unit operatively coupled to said printed circuit board, wherein the device is operable to be moved between a supporting position during said pre-testing operations and a clearance position during vibration testing of the printed circuit board.

### BRIEF DESCRIPTION OF THE DRAWINGS

Embodiments of deflection measurement apparatus, systems and methods will now be described with reference to the accompanying drawings in which:

FIG. 1 is a perspective view of an acoustical vibration testing system that could be used to perform vibration testing of a printed circuit board integrated thereto;

FIG. 2 is a schematic representation of two standard PCB formats showing predetermined locations of mounting holes that can be used to secure the board onto a mounting structure of a receiving system;

FIG. 3 is a schematic representation of a PCB under bending showing various geometrical parameters involved;

FIG. 4A is a perspective view of a basic PCB deflection measuring apparatus;

FIG. 4B is a schematic block diagram of the PCB deflection measuring apparatus of FIG. 4a;

FIG. 5 is a chart representing a relation between maximal deflection measurement values and span lengths for ensuring compliance with a predetermined minimum radius of curvature R=1500 mm, wherein span lengths are within a (0; 250 cm) range;

FIG. 6 is a chart representing a relation between maximal deflection measurement values and span lengths for ensuring compliance with a predetermined minimum radius of curvature R=1500 mm, wherein span lengths are within a (0; 50 cm) range;

FIG. 7A is a perspective view of the top side of a baffle to be installed on the acoustical enclosure of the vibration testing system shown in FIG. 1, provided with a mounting structure and supporting device for a printed circuit board;

FIG. 7B is a plan view of the baffle of FIG. 7A, showing a printed circuit board secured thereto;

FIG. 8 is a perspective view of the bottom side of the baffle of FIG. 7A, showing the supporting device;

FIG. 9A is a perspective view of PCB edge securing element for use with the PCB mounting structure shown in FIG. 7A;

FIG. 9B is a partial cross-sectional side elevation view along section lines 9B-9B of FIG. 7B, showing the PCB edge securing element in its operational position;

FIG. 10A is a perspective view of a plunger as part of a displaceable locking device provided on the supporting device of FIG. 7A;

FIG. 10B is a partial cross-sectional side elevation view along section lines 10B-10B of FIG. 7B, showing details of the plunger;

FIG. 11 is a perspective view of the top side of another example of baffle on which a plurality of PCB supporting devices are provided, allowing a plurality of PCBs to be simultaneously mounted on a same baffle;

FIG. 12 is a perspective view of the bottom side of the baffle of FIG. 11, showing the supporting devices;

FIGS. 13A and 13B are cross-sectional side views of the single PCB baffle and supporting device as shown in FIG. 7B along section lines 13-13, showing its pivoting and support locking mechanisms in their lowered, PCB disengaging position and lifted, PCB supporting position, respectively;

FIG. 14 is a plan view of the top surface of a printed circuit board to be tested showing the locations of securing points and unused mounting holes, with examples of bending measurement span locations where deflection and bending radius of the PCB secured at edges thereof by clamp assemblies provided on the mounting structure are measured, without support of the bottom side of the PCB;

FIG. 15 is a plan view of the top surface of the printed circuit board of FIG. 14, showing examples of bending measurement span locations, with support of the bottom side of the PCB;

FIG. 16a is a perspective view of another embodiment of deflection measuring apparatus, which is provided with load applying and measuring devices;

FIG. 16b is a schematic block diagram of the apparatus shown in FIG. 16a; and

FIG. 17 is a plan view of the top surface of the printed circuit board of FIG. 14, showing the locations of securing points and unused mounting holes, with examples of bending measurement span locations where deflection and bending radius of the PCB secured at edges thereof by the clamp assemblies are measured, with support of the bottom side of the PCB in a loading condition.

### DETAILED DESCRIPTION OF THE EMBODIMENTS

Some embodiments of PCB deflection measuring apparatus and methods that can prevent overstress of PCBs when testing or integrating thereof in a system will be described. In the context of an exemplary application wherein a printed circuit board as a device under test (DUT) is integrated to a vibration testing system, the deflection measuring apparatus and methods are used to prevent overstress of PCBs prior and during testing. For example, it can be used to verify in a HALT, HASS of ESS testing protocol, if the PCB testing fixture and vibration testing setup would be likely to cause failure of PCB components during pre-testing and testing procedures, which failure would otherwise not occur with faultless components. In that testing vibration context, it is possible to validate the selection of support locations amongst a number of locations existing on the PCB to be secured onto the mounting structure of the testing system, so that the bending limit requirement is met.

In the context of another exemplary application wherein a PCB is integrated to a system as a product such as a computer, the deflection measuring apparatus and methods are used to prevent overstress of PCBs at the system assembly stage, to ensure that operations involved, such as plugging of PCB connectors, will not cause PCB components failure, which would otherwise not occur with faultless components.

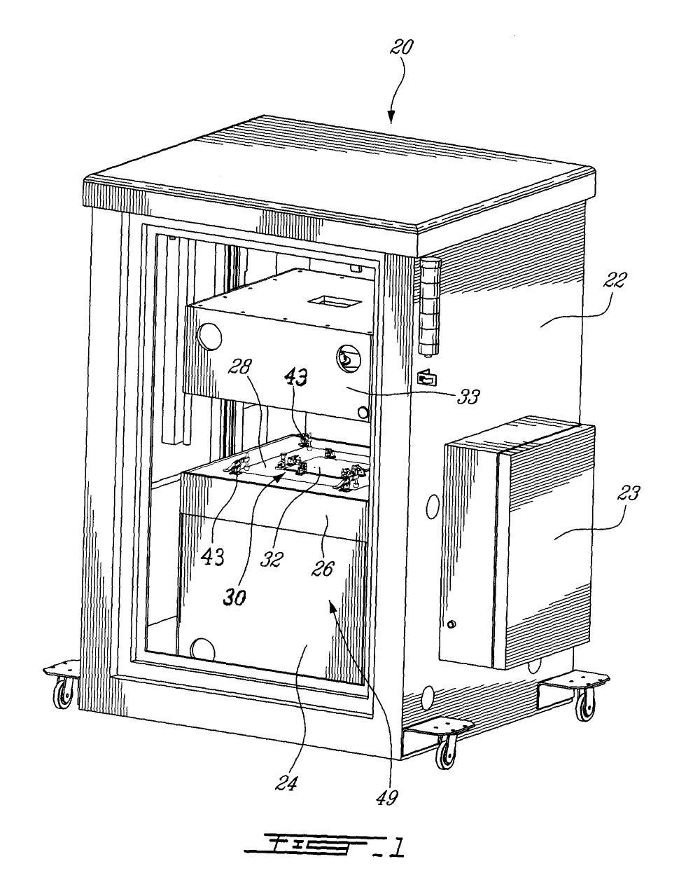

Referring to FIG. 1, an exemplary vibration testing system that can be used as generally designated at 20 is an acoustical vibration testing system such as described in detail in U.S. Pat. No. 6,668,650 B1 issued on Dec. 13, 2003 and now assigned to the present assignee, the entire disclosure thereof being incorporated herein by reference. Such vibration testing system 20 includes a vibrator unit generally designated at 49 and operatively coupled to a printed circuit board (PCB) 32 to be tested, which incorporates a testing chamber 22 (closable by a door not shown) including a main loudspeaker enclosure 24 provided with an upper module 26 adapted to receive a baffle 28 rigidly mounted thereon through attachments in the form of clamp assemblies 43, which baffle 28 is also used as a mounting structure to receive PCB 32 using securing means generally designated at 30, which mounting structure defines a reference mounting plane as will be later described in more detail. It can be seen from FIG. 1 that an upper loudspeaker enclosure 33 may be provided to generate complementary acoustical waves toward the top surface of the PCB 32 under test. The chamber 22 is provided with a controller unit 23 generating an amplified acoustical excitation signal for the loudspeaker enclosures 24 and 33.

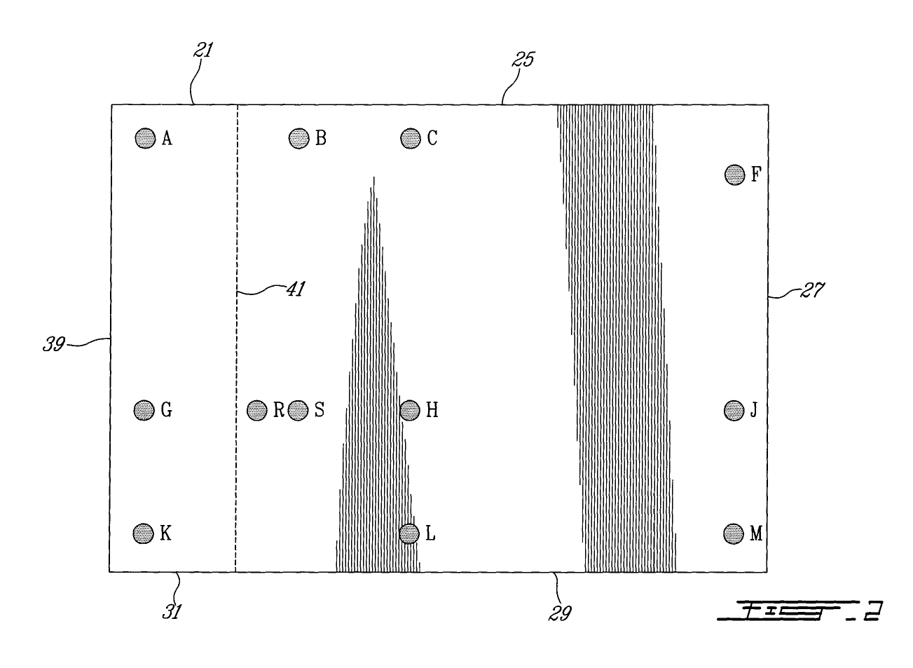

Turning now to FIG. 2, there is shown a schematic representation of two distinct PCB format according to ATX standards, showing the predetermined locations for mounting holes, designated as A, C, F, G, H, J, K, L and M for ATX format represented by the outline formed by line segments 21, 25, 27, 29, 31 and 39, and designated as B, C, F, H, J, L, M, R and S for microATX format represented by the outline formed by line segments 25, 27, 29 and 41. It is to be understood that the PCB deflection measuring apparatus, vibration testing system and related methods as herein described may be advantageously used with any standard or customized formats of PCB characterized by known mounting holes locations.

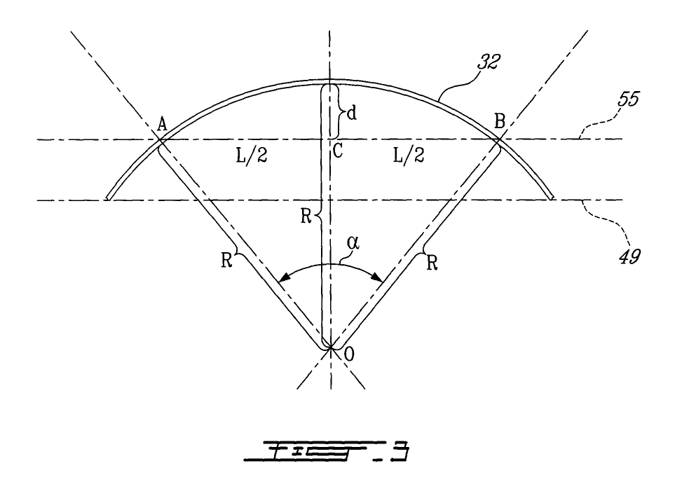

Turning now to FIG. 3, a geometrical method to define and derive a bending radius from a measured maximal deflection an associated bending span length will now be explained in view of some mathematical equations. In FIG. 3, a PCB under bending as schematically represented at 32 substantially forms a circle arc delimited by limit points A and B, the level of bending being characterized by a radius of curvature designated at R. It is pointed out that the amplitude of bending has been intentionally exaggerated in the representation of FIG. 3 for the purpose of explanation. While the actual bending profile may not be exactly represented by a perfect circle arc as shown in FIG. 3, such model can be considered as a good approximation. The length of segment L can be obtained as follows:

L=2R sin(α/2) (1)

The length of circle arc can be obtained as follows:

Arc=2πRα/360 (2)

then:

α=Arc 360/(2πR) (3)

wherein R is the circle radius and α is an angle defined by segments A-O and O-B shown in FIG. 3. From the preceding equation, the circle arc may be obtained as follows:

Arc=πR/90·A sin(L/(2R)) (4)

and the maximal deflection d to be measured, relative to an axis 55 passing through limit points A and B, is obtained as follows:

d=R−[OC] (5)

wherein: [OC]=R·cos(α/2)

The preceding equation (5) for d can be transformed as follows:

d=R−R·cos(Arc 360/(2πR/2) (6)

d=R−R·cos(Arc 90/(πR) (7)

d=R−R·cos[πR/90·A sin(L/(2R)·90/(πR))] (8)

d=R−R·cos[A sin(L/(2R))] (9)

While the radius of curvature may be obtained from a transformation of equation (9), it can be shown that the model as proposed by Stewart M. et al, in “New mechanical board bend test to demonstrate improved mechanical properties of soft termination”, 9th Annual Automotive Electronics Reliability Workshop, Nashville, AEC, 2004, is a reliable estimation, given by the following equation:

R=[((L/2)²+d²)/(2d)] (10)

In that model, the point C as shown in FIG. 3 is substantially equidistantly located between limit points A and B so that maximal deflection d can be obtained directly. It is to be understood that any other appropriate geometrical model could be used as a basis of bending curvature estimation for the purpose of the measurement method. For example, in a case where a point C located elsewhere along axis 55 would be used as a reference to define a deflection value not corresponding to the maximal deflection, an appropriate geometrical relation could be derived to estimate that maximal deflection. According to the equations defined above, the radius of curvature of a PCB during its installation on a mounting structure such as part of a vibration testing system 20 or other system as a product integrating the PCB can be measured to ensure that the level of bending does not exceed a predetermined limit preserving PCB integrity and ensuring functional reliability thereof.

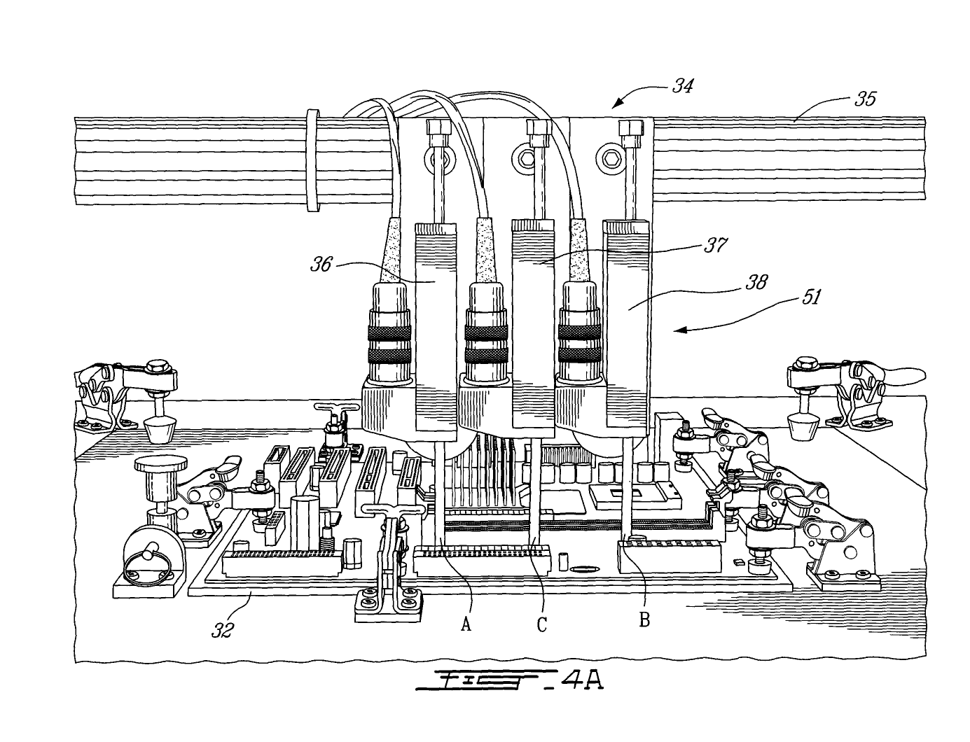

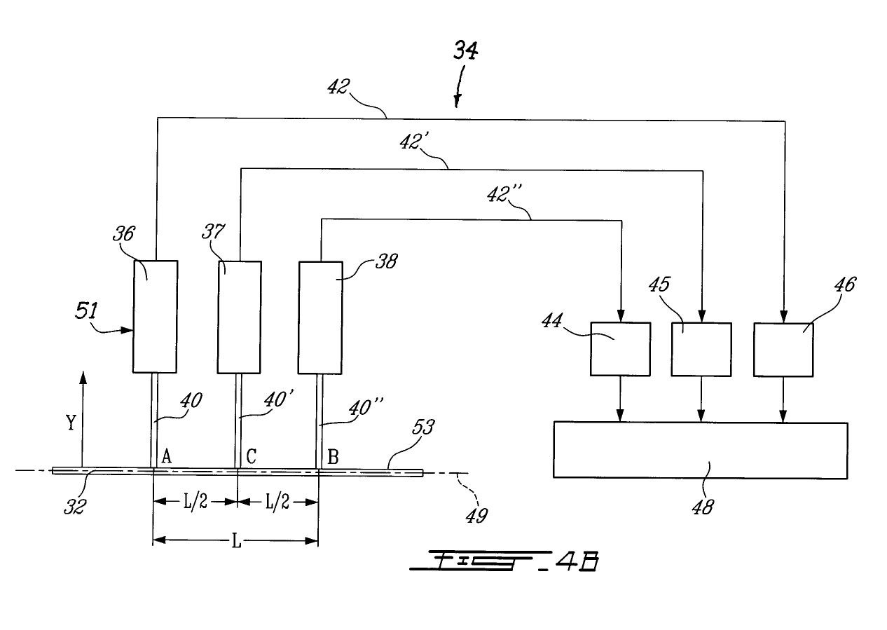

Referring to FIGS. 4A and 4B, using the deflection measuring apparatus generally designated at 34, preferably three points of measurement A, B and C located along a same axis at equal predetermined span length L/2 are shown, according to the geometrical model explained above in view of FIG. 3. The apparatus 34 is provided with a displacement measurement unit generally designated at 51, for measuring deflection of said printed circuit board 32 in a direction substantially perpendicular to reference mounting plane 49 at a representative number of measurement locations on printed circuit board 32. In the embodiment shown, the displacement measuring unit 51 includes first and second displacement measuring sensors 36, 38 directed substantially perpendicularly toward the mounting plane 49 and disposed in a predetermined spaced relationship to generate displacement values, with respect to mounting plane 49 in direction substantially perpendicular thereto, of first and second bending span limit points A and B on a surface 53 of printed circuit board 32, as better shown in FIG. 4B. The displacement measuring unit 51 shown further includes a third displacement measuring sensor 37 directed substantially perpendicularly toward reference mounting plane 49 and disposed between first and second sensors 36, 38 to generate a displacement value with respect to mounting plane 49 corresponding to a deflection measurement location on printed circuit board top surface 53. In the present example, the displacement measuring sensors 36, 37 and 38 are contacting sensors, and more particularly linear-voltage differential transformers (LVDTs) mounted on system frame 35, each being provided with a contact probe 40, 40′ and 40″, respectively, the extremity of which makes contact with top surface 53 of PCB 32 at selected locations thereon. It is to be understood that other displacement measuring sensors of any appropriate type such as dial gauges can be used as distance measuring devices, as well as any appropriate non-contacting probes such as a laser ranging devices. Furthermore, although the use of three sensors 36,37,38 is convenient, a single sensor that is successively disposed at appropriate measurement positions as shown in FIG. 4B according to the measuring span can be used. In the present example, the third sensor 37 is substantially equidistantly disposed between first and second sensors 36,38 so that each deflection measurement location is substantially equidistant from the corresponding span limit points A and B. Therefore, it can be seen from FIG. 4B that outer contact probes 40 and 40″ are spaced by a distance L while they are spaced from the central contact probe 40′ each by a distance of L/2. The displacement along vertical axis Y shown in FIG. 4b as detected by sensors 36, 37 and 38 is associated with a corresponding voltage output variation generated by each LVDT through corresponding respective output lines 42, 42′ and 42″, the voltage of which being measured by respective voltmeters 44, 45 and 46 which output readings can be sent to a data processor such as computer provided with memory as designated at 48, which is programmed for deriving a measured deflection value relative to printed circuit board top surface 53 at each measurement location from all displacement values generated by sensors 36,37,38. More particularly, the computer 48 is adapted to derive from these displacement values a reference value for the printed board top surface 53 partially delimited by bending span limits points A and B, and to subtract that reference value from the displacement value generated by third sensor 37, to derive the measured deflection at each measurement location relative to printed circuit board top surface 53. For so doing, on the basis of the measurements obtained from first and second sensors 36, 38, a voltage reference level associated with measurement span limit points A and B at selected locations on the PCB 32 is determined. Then, from the measurement of third sensor 37, displacement variation may be measured to estimate maximal deflection d between span limit points A and B as represented in FIG. 3, by subtracting from the measured output of third sensor 37 the reference level obtained from measurements made with first and second sensors 36 and 38, which displacement difference corresponds to the maximum deflection d. The computer 48 is further programmed for comparing the measured deflection with a predetermined limit deflection value, and to generate an indication whenever the measured deflection is without a range defined by that limit deflection value.

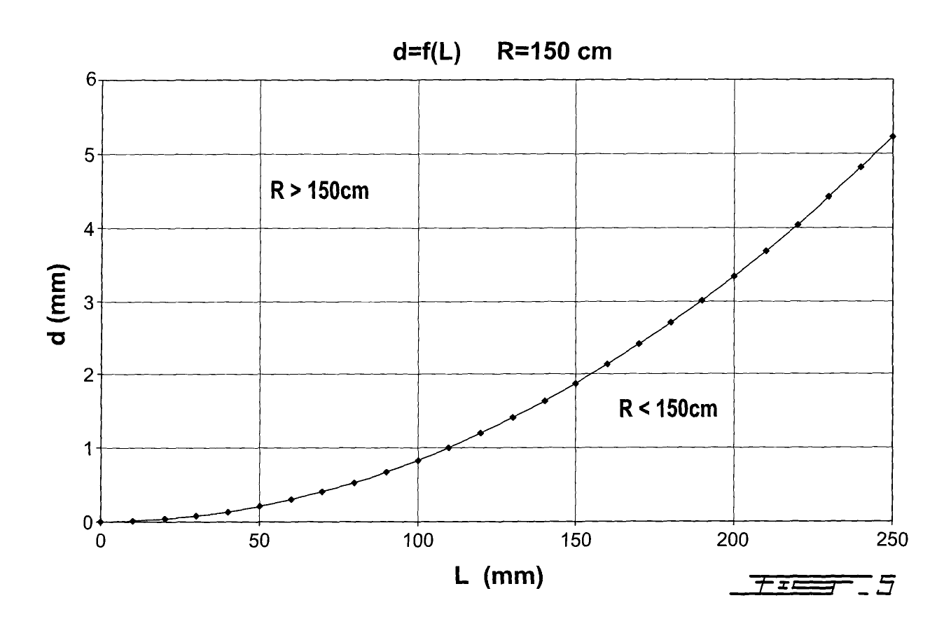

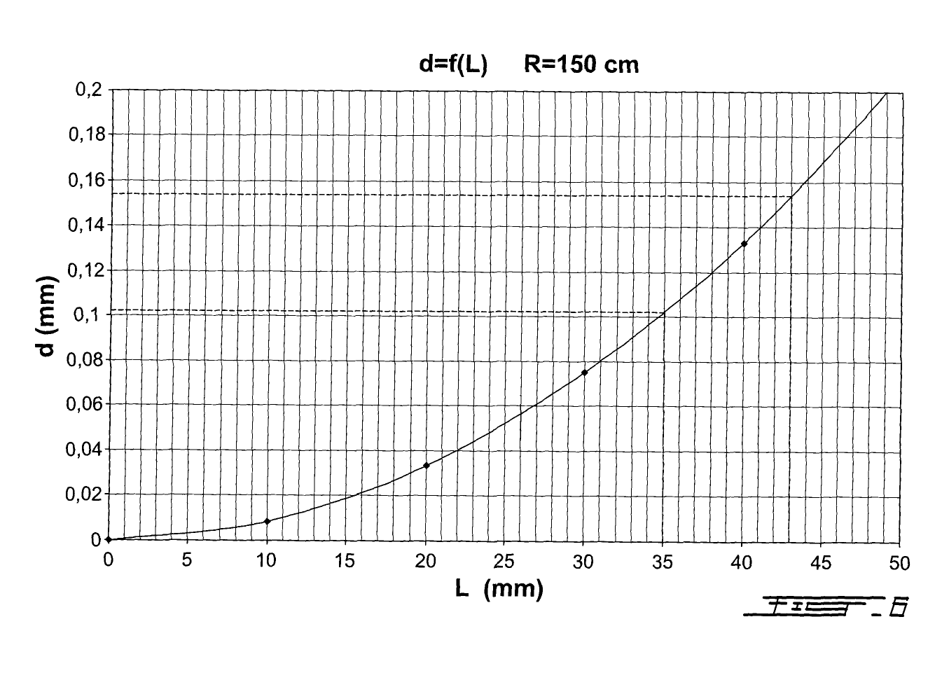

Applying equation (10) set forth above, it can be appreciated that the radius of bending curvature can be directly inferred from the measured deflection. Since the level of bending is inversely proportional to the value for the radius of curvature, the requirement to limit bending below a predetermined limit value may be expressed as a condition that any measured radius of curvature shall not be lower than a predetermined minimum radius of curvature. For example, assuming a minimum radius of curvature R=115 cm, it can be seen from the charts shown in FIGS. 5 and 6 experimentally obtained with values for L being within the ranges of {0; 250} cm and {0; 50} cm, respectively, that any radius of curvature of an estimated value R greater than (or equal to) the predetermined minimum limit of 115 cm complies with the requirement, while any measured radius of curvature that is lower than 1500 mm does not comply with that same requirement. Preferably, LVDTs are used to measure deflection d obtained with relatively long bending measurement span length, for example L≧43 mm, while a conventional dial gauge can be used to measure more localized deflection d obtained with relatively shorter bending measurement span length, for example when 35 mm ≧L≧43 mm. LVDTs and dial gauge model no TRS-50 from Novotechnik U.S. Inc. (Southborough, Mass.) can be used. The accuracy of such dial gauge being rated at 0.05 mm compared to the accuracy for LVDT rated at 0.075 mm, on the basis of a safety two-factor, maximum deflection d of 0.1 mm and 0.15 mm respectively can be measured. In view of the chart shown in FIG. 6, wherein the curve shows the maximum deflection d for a given span length L delimited by a pair of outer measurement points, it can be seen that a minimum span length L=35 must be used with a dial gauge, while a minimum span length L=43 mm must be used with a LVDT.

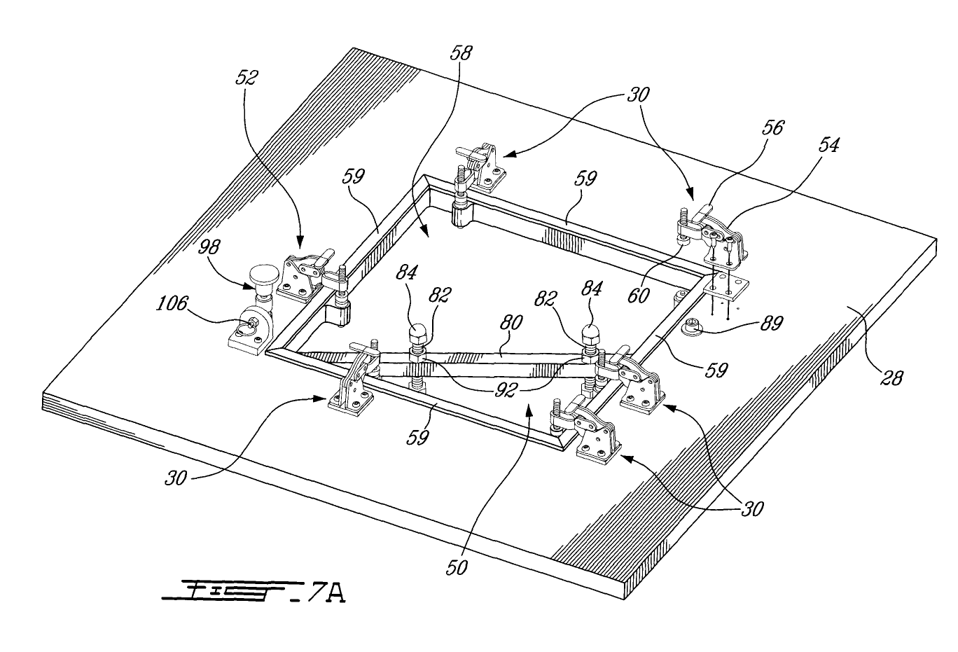

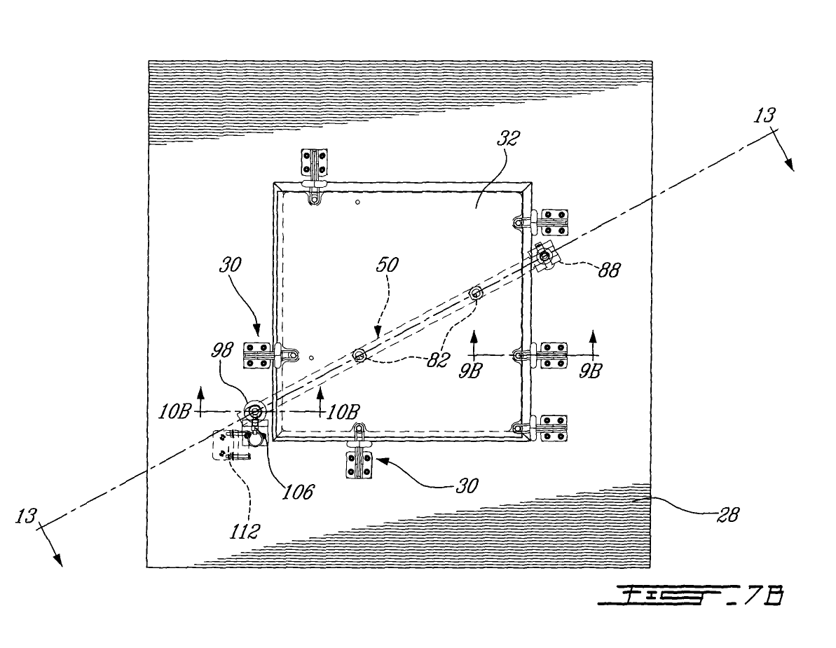

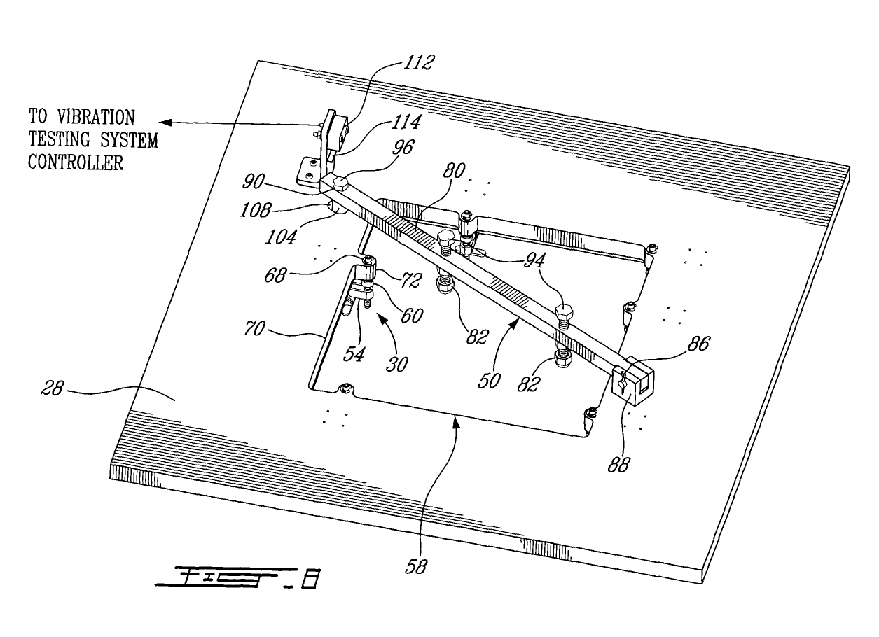

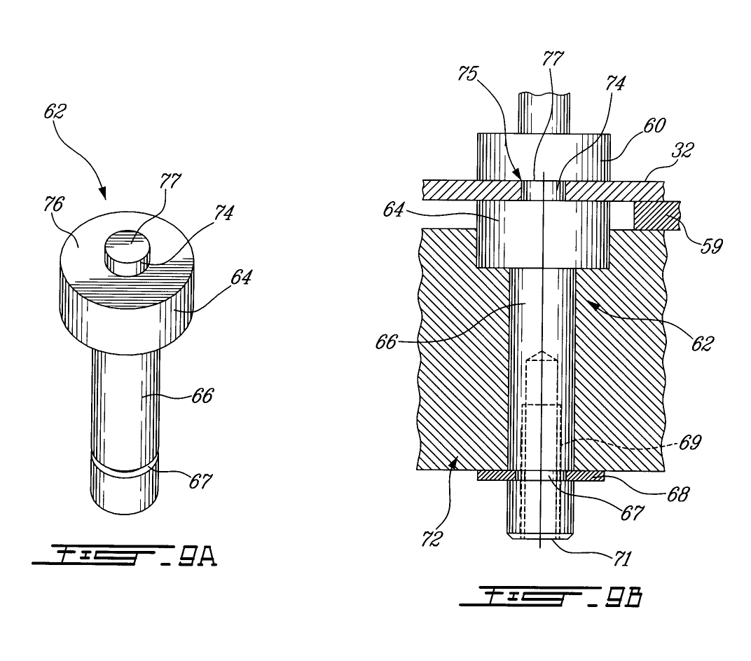

Referring now to FIG. 7A, secured onto the baffle 28 to be installed on the acoustical enclosure of the vibration testing system shown in FIG. 1 and forming a mounting structure for a PCB to be tested, is a PCB supporting device generally designated at 50, used for selectively supporting a printed circuit board at one or more selected locations on first, bottom surface of said printed circuit board 32 during pre-testing, setup operations. In the example shown involving a PCB 32 of a standard microATX format to be tested, the means for securing printed circuit board 32 on mounting structure 28 are in the form of a plurality of clamp assemblies generally designated at 30. The clamp assemblies 30 as shown are preferably of a similar design that the clamp assemblies described in U.S. Pat. No. 6,668,650 owned by the present assignee. It is to be understood that clamps of alternate design or other attachment devices of any appropriate type are also contemplated for securing the PCB onto the mounting structure 28. Each clamp assembly 30 includes a movable clamping mechanism designated at 54 that is operable to be moved between an open position when its handle 56 is manually lifted outwardly providing sufficient clearance for mounting a PCB to be tested onto the baffle 28, and a closed position by pushing down handle 56 inwardly toward the PCB top surface in order to rigidly secure a PCB edge area relative to the baffle 28, the PCB substantially covering baffle opening 58 so that acoustical waves will be transmitted to the PCB when a vibration test is carried out. Clamp assemblies 30 may be provided for a sufficient number of available mounting holes located at the edge around the PCB to be tested to ensure that it does not shift from its original mounting position during vibration testing at any vibration level required. As also shown in FIG. 7A, applied onto the inner edge of baffle 28 defining baffle openings 28 and throughout the perimeter thereof are acoustical insulation strips 59 that can be used to maximize the transfer of acoustical energy from the loudspeaker enclosure to the PCB under test. Each clamp assembly 30 further includes an upper contact element 60 adapted to engage a corresponding portion of the top side of a PCB near the edge thereof and further includes a corresponding lower contact element 62 as shown in FIGS. 9A and 9B having a head portion 64 and a shank portion 66 provided with a recessed section 67 adapted to receive a securing clip 68 to rigidly secure the lower contact element 62 within a corresponding recess extending through a seating portion 72 provided on the inner baffle edge defining baffle opening 58, as better shown in FIG. 8 in view of FIG. 9B. Alternatively, the free end of shank portion 66 may be provided with an axially extending threaded bore 69 adapted to receive a corresponding bolt, provided the baffle thickness be sufficient so that the bottom surface thereof are coplanar with the shank portion end surface 71. The head portion 64 defines a protruding pin 74 adapted to engage with a corresponding edge mounting hole 75 provided on PCB 32, with the top PCB surface surrounding the mounting hole 75 being coplanar with pin end surface 77 and contact surface of upper element 60 in such a manner that PCB 32 is secured between main bearing surface 76 of head portion 64 and upper contact element 60, while preventing overstress that could otherwise induce local deformation or bending of the PCB upon clamping thereof. The pin 74 ensures a repeatable mounting position of the PCB to be tested on baffle 28 with a predetermined tolerance typically of 0.5 mm to make sure that during the testing stage, all PCBs will tightly fit on the support. Furthermore, when the upper contact element 60 and the lower contact element 62 are brought to the PCB securing position, appropriate clearance for all through-hole part pins along the PCB edge perimeter is provided. The main bearing surfaces 76 of all lower contact elements 62 when inserted within their corresponding baffle seating portions 72 must be as coplanar as possible to ensure that the PCB is not adversely stressed. The pin 74 and main bearing surface 76 are made with or covered by an electrostatic discharge preventing plastic material such as TIVAR™ 88 supplied by PHS Americas (Fort Wayne, Ind.) to ensure that the mounting holes of the PCB will not be damaged during vibration testing.

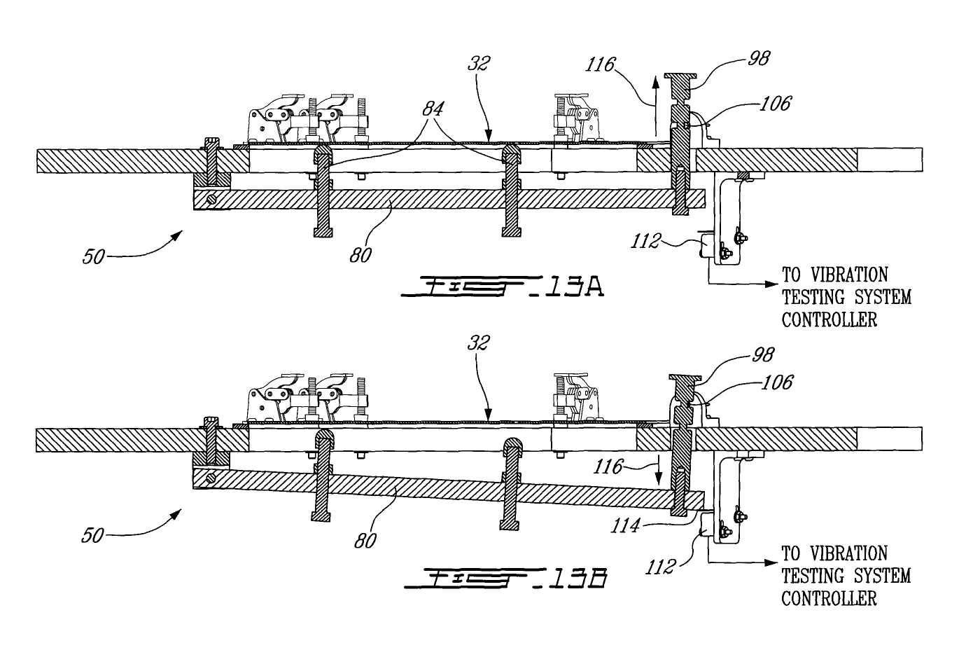

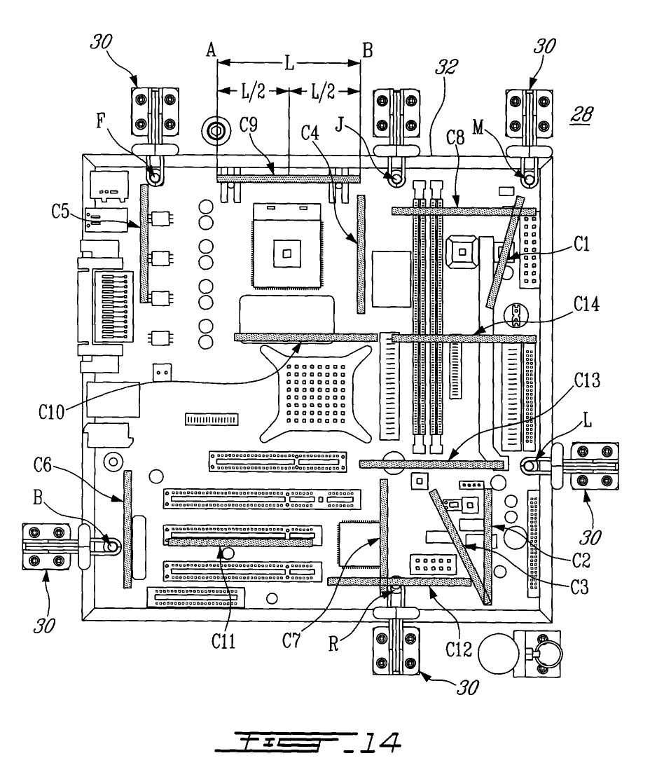

Turning back to FIG. 7A in view of FIG. 8, the PCB supporting device 50 device is operable to be moved between a supporting position during vibration pre-testing, setup operations and a clearance position during vibration testing of printed circuit board 32. For so doing, PCB supporting device 50 is provided with a displaceable member 80 to which is mounted one or more supporting elements 82, each defining a contacting support head 84 as better shown in FIG. 7A. In the embodiment shown in FIG. 8, a first end 86 of the displaceable member 80 is pivotally mounted to the bottom side of baffle 28 through a pivot assembly 88 secured against the bottom surface of baffle 28 through a bolt 89 as shown in FIG. 7A. The second end 90 of displaceable member 80 can be moved between a first, supporting position where the contacting support head 84 of each supporting element 82 is in contact with a surface area of PCB bottom side at predetermined locations, allowing pre-testing operations, and a second, disengaged position where the contacting support head 84 of each supporting element 82 is distant from the bottom side surface of PCB for allowing a test to be performed, as will be later explained in more detail with reference to FIGS. 13A and 13B. It can be seen from FIG. 7A that the transverse position of each contacting support head 84 with respect to displaceable member 80 can be manually adjusted using a nut 92 provided on each supporting element 82, which conveniently uses a threaded bolt 94 extending through a corresponding bore provided through displaceable member 80 as shown in FIG. 8. The second end 90 of displaceable member 80 is further provided with a bore extending therethrough adapted to receive a securing bolt 96 as shown in FIG. 8 for rigidly mounting a plunger 98 as better shown in FIG. 7A as part of a locking mechanism provided on the PCB supporting device 50 which is used to selectively lock the supporting device either in its supporting or unengaged positions as will be later explained in more detail with reference to FIGS. 13a and 13b.

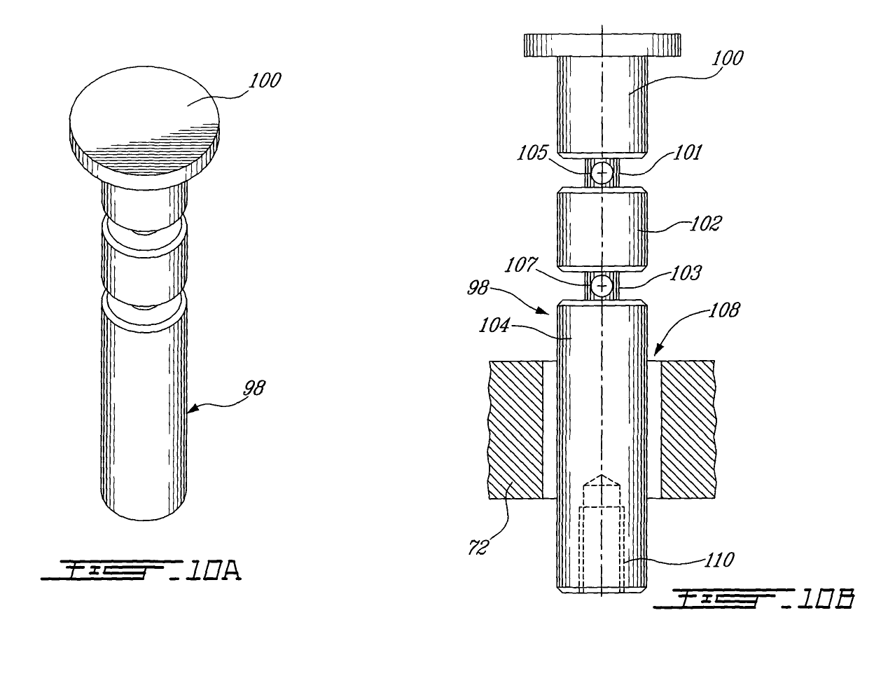

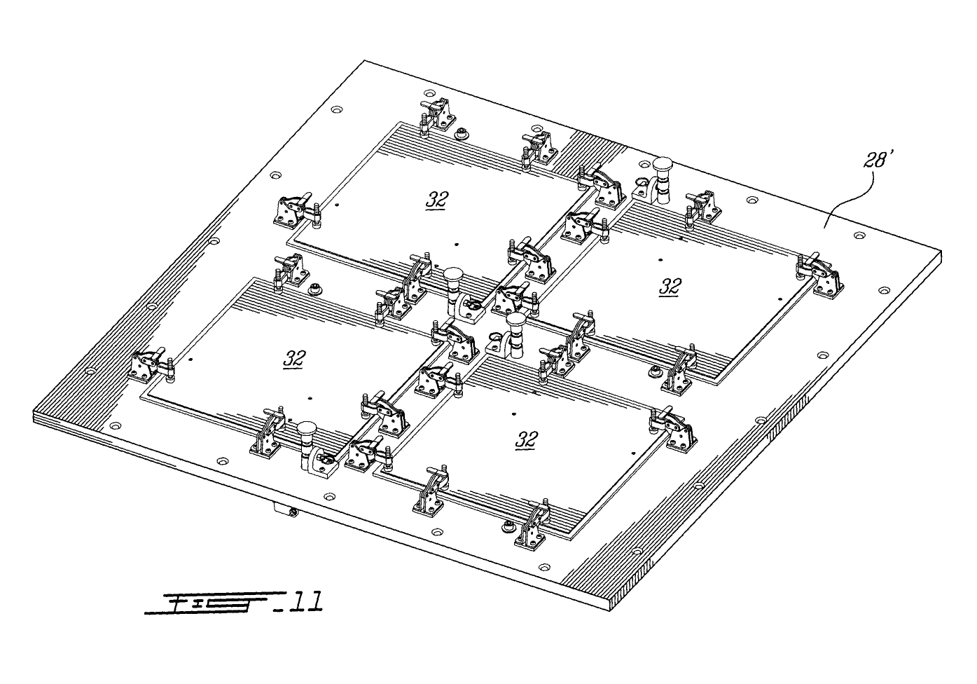

Turning now to FIGS. 10A and 10B, the plunger 98 is provided with a head portion 100 forming a handle, an intermediate body cylindrical portion 102 and a base cylindrical portion 104 which are interconnected by recessed cylindrical portions 101 and 103 of smaller diameters, which are provided with respective bores 105, 107 radially extending therethrough and adapted to receive a set pin 106 extending through the bore of a mounting flange 109 secured onto baffle 28 as shown in FIG. 7A.

Turning back to FIG. 8, the base portion 104 of plunger 98 is received within a bore 108 extending throughout the thickness of baffle 28, such bore 108 being preferably of an elliptical or equivalent section to provide the clearance required by the movement of plunger 98 upon pivotal of displaceable member 80 about pivot assembly 88 between the two limit positions. As shown in FIG. 10B, plunger base portion 104 is provided at lower end thereof with a threaded bore 110 for receiving securing bolt 96 shown in FIG. 8. It can be appreciated that the location of pivot assembly 88 and baffle bore 108 are chosen to ensure that the supporting elements 82 are precisely aligned with the areas of PCB bottom side that required support according to the selection of mounting holes ensuring that PCB bending does not exceed the set limit value. The PCB supporting device 50 can be operatively coupled to a support position sensor 112 whose output is in turn operatively coupled to controller 23 of the vibration testing system 20 shown in FIG. 1, for providing a signal indicating whether the supporting device is in its active, supporting position for preventing operation of said vibrator unit, or in its inactive, unengaged position enabling a test to be carried out. Conveniently, the support position detecting device 112 may be a conventional mechanically activated limit switch having a contact probe 114 disposed at a location adjacent the second end 90 of displaceable member 80 whenever the latter is brought toward its lowered, unengaged position upon manual displacement of plunger 98 toward its lowered position. It is to be understood that any other appropriate position detecting device, such as a photocell-based unit, may be used.

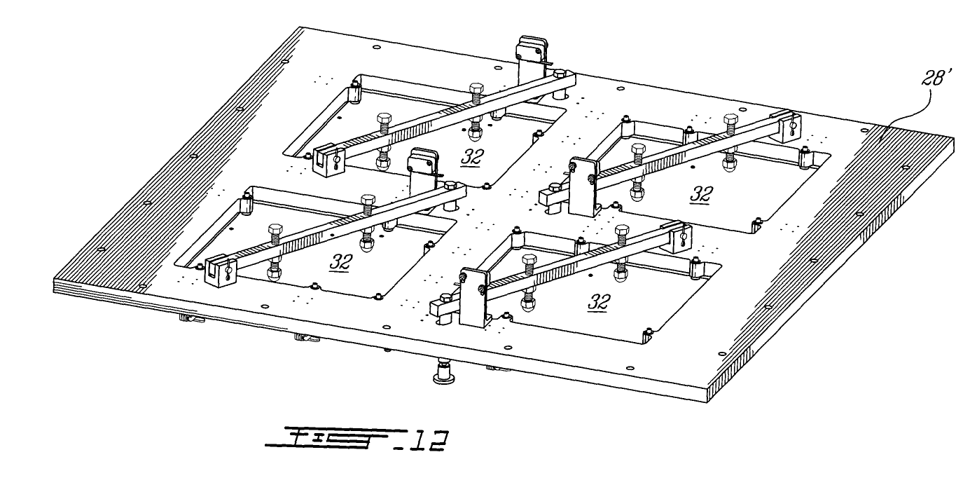

Turning now to FIGS. 11 and 12, there is shown another example of baffle 28′ to which are mounted four PCB supporting devices for enabling simultaneous testing of four PCBs 32, thereby increasing testing productivity.

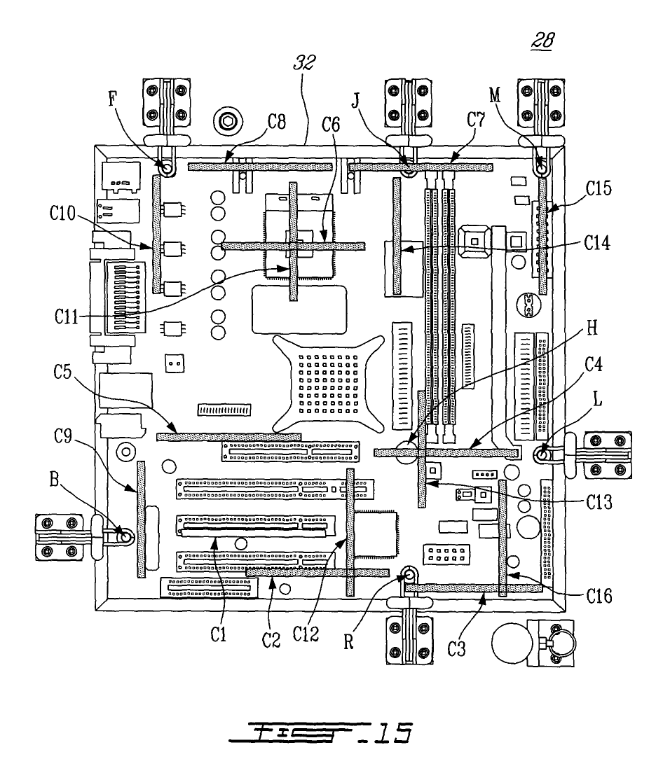

Referring now to FIG. 14, there is shown an exemplary, typical microATX PCB 32 mounted onto a baffle 28 with a supporting device including six clamp assemblies 30 shown in securing positions along the outer edges of PCB 32. Since securing of PCB 32 to be tested must not cause overbending thereof, the PCB bending level throughout its surface was controlled by measuring for a representative set of locations the bending radius to ensure that it does not exceed the predetermined minimum limit value when the PCB 32 is secured onto the baffle 28 with clamp assemblies 30 brought in their closed position. For so doing, measurements was performed using the deflection measuring apparatus 34 as described above with reference to FIGS. 4A and 4B, after the PCB supporting device 50 has been brought to its unengaged position as shown in FIG. 13B upon lowering down plunger 98 in the direction of arrow 116, which plunger 98 is then locked in that inactive position by insertion of set pin 106 through bore 105 provided on the recessed upper portion 101 of plunger 88 as shown in FIG. 10B. Prior to proceed with bending measurements on a PCB 32 to be tested, the displacement sensors 36, 37 and 38 of the deflection measuring apparatus 34 shown in FIGS. 4A and 4B were calibrated by measuring voltage values generated for each of them when respective probe 40, 40′, 40″ are disposed in contact with a straight reference bar (not shown) corresponding to a null (0) reference level, which reference voltage values was used to derive voltage variation ΔV due to displacement with respect to reference level. Then, while maintaining the physical position of sensors 36, 37 and 38 on the system frame 35 as shown in FIG. 4A, each one of LVDT probes 40, 40′, 40″ was raised to allow the mounting of a PCB 32 to be tested onto the baffle 28, which PCB 32 was rigidly secured thereto using clamp assemblies 30. Then, a series of displacement measurement was performed on areas of the PCB top surface at regions of interest such as near mounting hole locations and PCB center area, in order to obtain representative indications of bending effect throughout the surface of PCB 32. An example of bending radius measurements obtained for the PCB 32 shown in FIG. 14 is given in Table 1.

TABLE 1

| | | RESULTS | | |
|---|---|---|---|---|
| Coordinates | | | d | |
| | Mounting | | Deflection | BENDING |
| # | Hole | L/2 (mm) | (mm) | Radius (mm) |
| C1 | M | 20.8 | 0.025 | 8651 |
| C2 | L | 20.8 | 0.027 | 8140 |
| C3 | L | 20.8 | 0.016 | 13146 |
| C4 | J | 20.8 | 0.002 | 96245 |
| C5 | F | 20.8 | 0.011 | 19169 |
| C6 | B | 20.8 | 0.008 | 28054 |
| C7 | R | 20.8 | 0.037 | 5888 |
| C8 | M-J | 20.8 | 0.022 | 9961 |
| C9 | J-F | 20.8 | 0.034 | 6273 |
| C10 | Center | 20.8 | 0.026 | 8340 |
| C11 | B | 20.8 | 0.040 | 5362 |
| C12 | R | 20.8 | 0.022 | 9724 |
| C13 | L-H | 20.8 | 0.013 | 16671 |
| C14 | Center | 20.8 | 0.019 | 11684 |

Conveniently, the values for L/2 (mm) were directly obtained by measuring the distance separating LVDT probes 40,40′,40″. The deflection value (mm) was obtained from the voltage variation signals with respect to the reference level as generated by sensors 36, 37 and 38 in the following manner. First, the voltage variations measured for outer sensors 36 and 38 were averaged to obtain a main voltage variation value. Then a difference between the voltage variation value measured with central sensor 37 and the average voltage variation value was calculated by computer 48 to obtain a resulting deflection d (mm). Finally, using equation (10), the bending radius (mm) was estimated from values for deflection d and values for L/2 (mm). It can be seen from the resulting radius values given in Table 1 that the requirement based on minimum bending radius R=1500 mm was clearly met for all measurement coordinates C1 to C14. Whenever a bending radius measurement made at a given location does not comply with the minimum bending radius criterion, a new configuration for clamp assemblies 30 must be determined on the basis of which an additional series of measurements is performed until the minimum bending radius requirement is met.

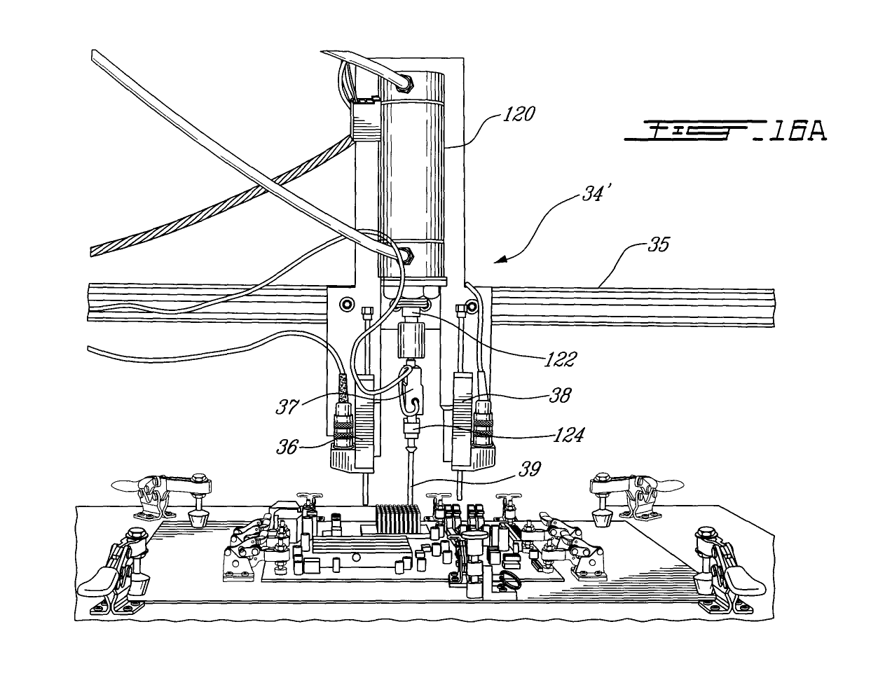

In order to minimize the risk that an operator performing a pre-testing setup on a PCB unintentionally overbends the PCB, thereby inducing stress that damages it, the PCB deflection measuring apparatus and its method were used to ensure that, at representative locations on the surface of the PCB, the bending radius when a load is applied onto the PCB top side, for example by adding daughter-boards, power cables, connectors, etc. during a pre-testing setup, does not exceed a predetermined value, to preserve PCB integrity and ensuring its reliability. Such requirement can be met by first characterizing the effect of the supporting apparatus itself before any load is applied on the PCB, with at least one selected support position within the perimeter defined by the PCB, for example mounting holes Hand CPU socket measurement locations designated at C6 and C11 on FIG. 15 representing the same PCB 32 to be tested as shown in FIG. 14. These measurement locations were selected since no component or conducting path was found at these locations that could cause short circuit. Furthermore, it was expected that the predetermined bending radius limit requirement was likely to be met when one or more of existing mounting holes determined at the design stage of the PCB were selected. For so doing, the displaceable member 80 of the supporting device 50 was brought to its active, PCB supporting position as shown in FIG. 13A wherein the contacting support head 84 of each supporting element 82 makes contact with PCB bottom surface at the selected location thereon, thereby preventing relative movement of the PCB contacted portion to minimize PCB bending. It can be appreciated form FIG. 13A that when the displaceable member 80 is brought to its supporting position upon lifting up of plunger 98 in the direction of arrow 116, such active position may be locked by insertion of set pin 106 through the lower bore 107 provided on plunger 98 as shown in FIG. 10B. It can also be seen from FIG. 13A that when the displaceable member 80 is brought in the supporting position, the detecting device 112 is in its deactivated state, thereby indicating to the vibration system controller that the test cannot be performed. After having proceeded with reference voltage level measurement using the same calibration bar referred to above, the measurement was repeated in the same manner as explained before to obtain deflection values from which bending radius may be derived. An example of deflection measurement and bending radius calculation results for the PCB 32 shown in FIG. 15 is given in Table 2.

TABLE 2

| Coordinates | | RESULTS | | |
|---|---|---|---|---|
| | Mounting | | d | BENDING |
| # | Hole | L/2 (mm) | Deflection (mm) | Radius (mm) |
| 1 | B | 20.8 | 0.077 | 2813 |
| 2 | R | 20.8 | 0.014 | 15751 |
| 3 | R | 20.8 | 0.093 | 2326 |
| 4 | L | 20.8 | 0.098 | 2208 |
| 5 | C | 20.8 | 0.087 | 2488 |
| 6 | CPU | 20.8 | 0.080 | 2702 |
| 7 | M-J | 20.8 | 0.038 | 5619 |
| 8 | F-J | 20.8 | 0.053 | 4097 |
| 9 | B-C | 20.8 | 0.065 | 3343 |
| 10 | F-J | 20.8 | 0.001 | 262016 |
| 11 | CPU | 20.8 | 0.045 | 4821 |
| 12 | R-H | 20.8 | 0.052 | 4136 |
| 13 | R-H | 20.8 | 0.081 | 2678 |
| 14 | J | 20.8 | 0.111 | 1944 |
| 15 | M | 20.8 | 0.042 | 5155 |
| 16 | L | 20.8 | 0.051 | 4202 |

It can be seen from Table 2 that the minimum bending radius requirement R=1,500 mm was met for all measurement locations C1 to C16 that were considered. Whenever the bending radius measurement obtained for a given location does not comply with the minimum bending radius requirement, a new configuration of support locations provided by the PCB supporting device 50 must be determined on the basis of which the measurement procedure is repeated until the requirement is met.

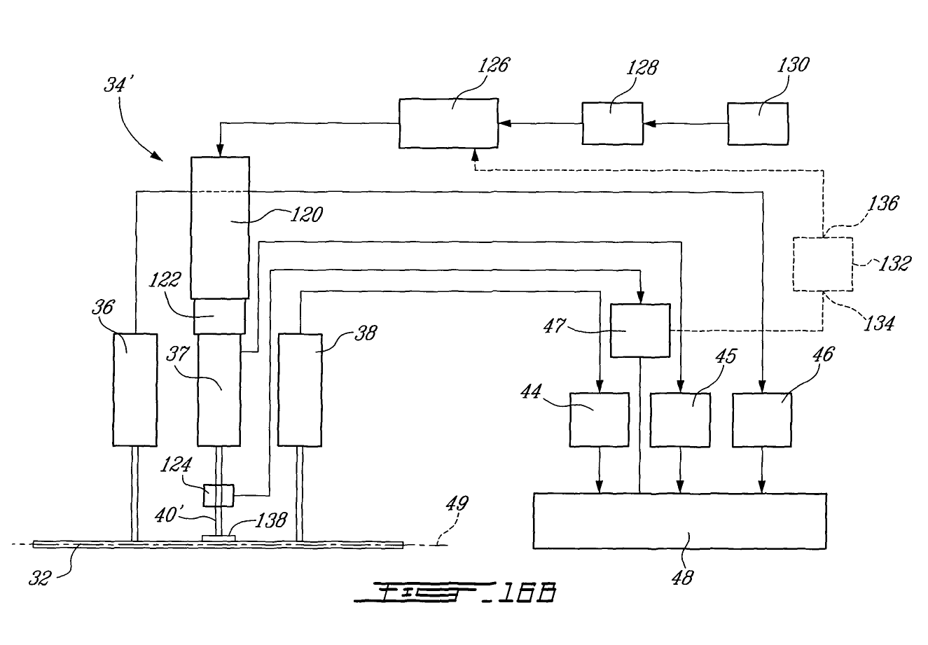

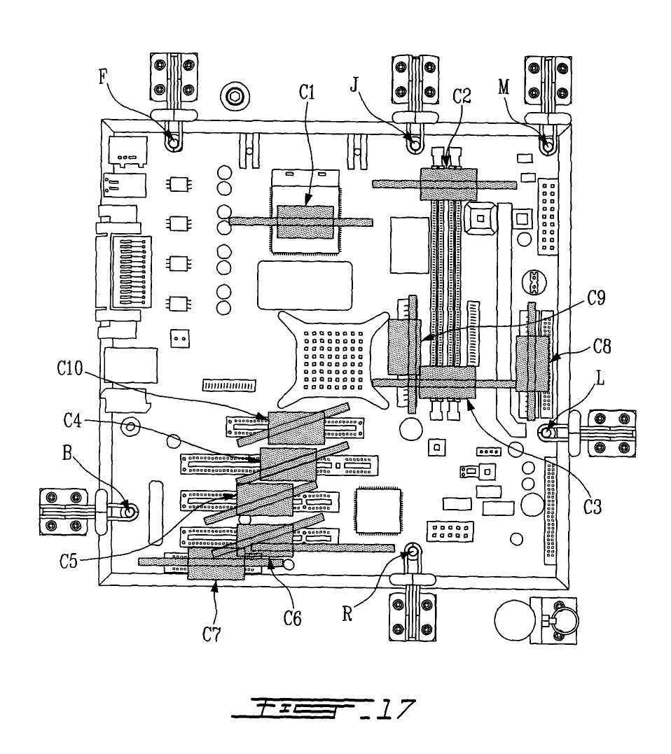

Referring now to FIGS. 16A and 16B, another embodiment of deflection measurement apparatus 34′ can be used to simulate loading conditions that typically prevail when an operator handles a PCB for performing an operation thereon such as daughter-board or connector insertion into corresponding sockets provided on the PC board to be tested, or to be integrated in a receiving system. For so doing, a reasonable value for such maximum load has been experimentally set to 66 N, which value was used in the example that will be later presented. The modified deflection measuring apparatus 34′ physically includes the same elements as included in the basic deflection measuring apparatus 34 described before with reference to FIGS. 4A and 4B, with some additional elements that are provided to perform load application and measurement functions. As shown in FIG. 16B, the modified apparatus 34′ further includes a load applying device 120 directed substantially perpendicularly toward reference mounting plane 49 and disposed between first and second sensors 36, 38 to apply a predetermined load on printed circuit board surface 53 at measurement location thereon. Conveniently, the load applying device may be a pneumatic cylinder such as supplied by Bimba manufacturing Co. (Monee, Ill.) operatively coupled to the probe 40′ of central sensor 37 through piston 122 for simultaneously applying the predetermined load onto a selected location of PCB 32 while repeating the measurement of relative displacement from voltage variation from sensor 37 in the same manner as explained before. Furthermore, in order to ensure that the actual load applied to the PCB 32 corresponds to the preset load value, a force detector such as piezoelectric detector 124 can be coupled to the probe 40′ of sensor 37 to generate a corresponding load measurement signal to a further voltmeter 47. On the basis of the standard calibration curve characterizing the relation between a given voltage reading and the corresponding force measurement value, the load applied by piston 122 of device 120 can be adjusted using an air pressure regulator 126 connected to a pressurized air source 130 through a main valve 128. Optionally, a controller 132 having an input 134 connected to an output of voltmeter 47 and having an output at 136 coupled to a controlled input provided on air pressure regulator 126 in a feedback configuration may be used. It is to be understood that any other appropriate actuating device such as an electrical powered linear actuator can be used as load applying means. So as to prevent any damage of PCB surface or components upon application of the predetermined load, a protecting plate 138 can be disposed between the contact end of central probe 40′ and the PCB loaded area, which plate being represented by a dark rectangle associated with each bending measurement span at location coordinates C1 to C10 shown in FIG. 17. As compared with the calibration procedure explained above when performing deflection measurement with the apparatus 34 while no load is applied to the PCB and for which a single calibration step is sufficient prior to proceed with the series of measurements at the selected PCB locations, the modified apparatus 34′ provided with load applying and measurement functions is preferably calibrated prior to each set of measurements at each selected location on PCB 32 to enhance the reliability of the results. Once reference voltage values associated with sensors 36, 37 and 38 with no load applied by piston 122 as well as reference level for piezoelectric detector 124 are obtained, the cylinder of device 120 is caused to be fed with pressure air from regulator 126 according to the preset value. Table 3 presents an example of bending radius values that were obtained for the printed circuit board 32 shown in FIG. 17 involving bend measurement locations that were selected corresponding to various connectors and sockets.

TABLE 3

| | RESULTS | | |
|---|---|---|---|
| Coordinates | | d | BENDING |
| # | L/2 (mm) | Deflection (mm) | Radius (mm) |
| C1 | 22.75 | 0.120 | 2150 |
| C2 | 22.75 | 0.121 | 2141 |
| C3 | 22.75 | 0.128 | 2018 |
| C4 | 22.75 | 0.062 | 4166 |
| C5 | 22.75 | 0.112 | 2315 |
| C6 | 22.75 | 0.139 | 1858 |
| C7 | 22.75 | 0.149 | 1738 |
| C8 | 22.75 | 0.065 | 3978 |
| C9 | 22.75 | 0.092 | 2818 |
| C10 | 22.75 | 0.098 | 2629 |

It can be seen from the bend radius values given in Table 3 that all bending measurements for locations C1 to C10 comply with the minimum radius requirement R=1,500 mm. In the case where such requirement were not met, a new selection of support locations should have been made, which could have involved alternative existing mounting hole locations. The support configuration validation procedure carried on with the deflection measuring apparatus 34, involving deflection measurements with preset load applied to the PCB, must be repeated until the minimum bending radius requirement is met. Following the successful completion of all series of measurements described above, the PCB 32 is ready for vibration testing, provided the displaceable member 80 of PCB supporting device 50 is brought back to its inactive, unengaged position as shown in FIG. 13B, thereby indicating to the vibration testing system controller through the activation of detector 112 that a test may be safely carried on.

For the purpose of verifying if a PCB can be integrated in an end product system without damage, a same apparatus that described above can be used, but without the PCB supporting device. In that application, the deflection measuring apparatus can be installed on a system prototype used as a testing bench, provided with a same mounting structure than used by the end product system. The PCB is first secured to the mounting structure using the same attachment means as used for the system assembly. Deflections the PCB in a direction substantially perpendicular to the reference mounting plane at a representative number of measurement locations on the PCB are measured and compared by the data processor to a predetermined limit deflection value, as explained above. The measurements may be performed simultaneously with the securing operation, or following partial or complete PCB securing. If the measured deflections are within a range defined by the limit deflection value, it is an indication that the mounting structure with attachments means used do not overstress the PCB. In a case where some assembly operations likely to induce stress to the PCB are planned, such operations may then be actually performed or simulated with the load applying device provided on the deflection apparatus as described above, while deflection measurements are performed. If the measured deflections still comply with the limit requirement, it is an indication that the proposed PCB mounting means and assembly operations can be safely used in the system assembly line. However, if the measured deflections are found without that predetermined range, this is an indication that the proposed mounting structure, attachments means and/or assembly operations overstress the PCB at a level that may cause a component failure, and must be reviewed prior to be subjected to a further test.

It can be appreciated that the PCB deflection measurement device according to the embodiments as described above can be used according to any PCB mounting orientation with respect to the receiving system. For example, a PCB may be mounted under a top plate of the system frame, with its surface populated with components and connectors facing downwardly. In such case, the deflection measuring apparatus can be mounted in an inverted orientation as compared with that shown in FIGS. 4A and 4B. It is to be understood that alternative mechanisms capable of providing the movement of supporting elements 82 between their supporting and unengaged positions may be used in replacement of the pivoting displaceable member 80 as described above. For example, such alternate displaceable mechanism may use a linear actuator coupled to a transverse member having both ends mounted for sliding to a pair of opposed rails, the back and forth movement of which allowing supporting elements to selectively engage or disengage the bottom side of a PCB at the selected location thereon. According to a further alternate mechanism, each supporting element can be coupled to an independent actuator to provide more flexibility in the selection of support locations for the PCB. Moreover, the position locking mechanism may be provided with an actuator coupled to the plunger to provide an automatic selective movement between both locking positions. Furthermore, in a case where a testing procedure would involved the loading of both surfaces of the PCB under test, two deflection sensor units could be mounted with respect to top and bottom surfaces of the PCB, with two corresponding load applying devices where loading simulation is desired.

It is further to be understood that the PCB deflection measuring apparatus and methods as described above may be used with other types of vibration testing systems such as electrodynamic, hydraulic or pneumatic, as well as with a variety of electronic systems found in technological fields such as telecommunication, automation and instrumentation.

1. A method for measuring deflection of a printed circuit board (32) adapted to be integrated to a system (20) provided with a mounting structure (28) defining a reference mounting plane (49), said method comprising the steps of:
i) securing said printed circuit board (32) onto said mounting structure (28);
ii) measuring deflection of said printed circuit board (32) in a direction substantially perpendicular to said reference mounting plane (49) at a representative number of measurement locations on said printed circuit board (32) by:
a) measuring displacement values with respect to said mounting plane (49) and in a direction substantially perpendicular thereto of first and second bending span limit points on a surface of said printed circuit board (32);
b) measuring a displacement value with respect to said mounting plane (49) and in a direction substantially perpendicular thereto of a point located between said first and second bending span limit points; and
c) deriving from said displacement values obtained at said step a) a reference value for the printed board surface partially delimited by said bending span limits points; and
d) subtracting said reference value from said displacement value obtained at said step b) to derive said measured deflection at said location relative to said printed circuit board surface; and
iii) comparing said measured deflection with a predetermined limit deflection value.

2. The method according to claim 1, wherein said step iii) comprises generating an indication whenever said measured deflection is outside a range defined by said limit deflection value.

3. The method according to claim 1, further comprising, simultaneously to said step ii), a step of selectively applying a predetermined load on said printed circuit board surface at each said measurement location thereon.

4. The method according to claim 1, wherein each said deflection measurement location is substantially equidistant from the corresponding said span limit points, said measured deflection being a maximal deflection measured between said span limit points.

5. (canceled)

6. The method according to claim 1, wherein said step c) is performed by calculating an average from said displacement values obtained at said step a).

7. The method according to claim 1, wherein said system is a testing system adapted to test said printed circuit, said method further comprising the steps of:
iv) supporting said printed circuit board (32) at one or more selected locations on a first surface of said printed circuit board (32); and
v) repeating said steps ii) and iii) on said supported printed circuit board (32).

8. The method according to claim 7, wherein said step iii) comprises generating an indication whenever said measured deflection is outside a range defined by said limit deflection value.

9. The method according to claim 7, further comprising the steps of:
vi) selectively applying a predetermined load on a second surface of said printed circuit board surface at locations thereon corresponding to each said measurement locations; and
vii) repeating said steps ii) and iii) on said loaded printed circuit board (32).

10. An apparatus (34) for measuring deflection of a printed circuit board (32) adapted to be integrated to a system provided with a mounting structure (28) defining a reference mounting plane (49), said apparatus comprising:
means (30) for securing said printed circuit board (32) onto said mounting structure (28);
a displacement sensor unit (51) for measuring deflection of said printed circuit board (32) in a direction substantially perpendicular to said reference mounting plane (49) at a representative number of measurement locations on said printed circuit board (32), said displacement sensor unit (51) comprising:
first and second displacement measuring sensors (36,38) directed substantially perpendicularly toward said mounting plane (49) and disposed in a predetermined spaced relationship to generate displacement values with respect to said mounting plane (49) of first and second bending span limit points on a surface of said printed circuit board (32);
a third displacement measuring sensor (37) directed substantially perpendicularly toward said reference mounting plane (49) and disposed between said first and second sensors to generate a displacement value with respect to said mounting plane (49) corresponding to a deflection measurement location on said printed circuit board surface; and
processing means (48) for deriving said measured deflection relative to said printed circuit board surface at said measurement location from all said displacement values, and for comparing said measured deflection with a predetermined limit deflection value, said processing means (48) being adapted to derive from said displacement values generated by said first and second sensors (36,38) a reference value for the printed board surface partially delimited by said bending span limits points, and to subtract said reference value from said displacement value generated by said third sensor (37) to derive said measured deflection at said measurement location relative to said printed circuit board surface.

11. (canceled)

12. The apparatus (34) according to claim 10, wherein said third sensor (37) is substantially equidistantly disposed between said first and second sensors so that each said deflection measurement location is substantially equidistant from the corresponding said span limit points, said measured deflection being a maximal deflection measured between said span limit points.

13. The apparatus (34′) according to claim 10, further comprising:
a load applying device (120) directed substantially perpendicularly toward said reference mounting plane (49) and disposed between said first and second sensors (36,38) to apply a predetermined load on said printed circuit board surface at said measurement location thereon.

14. The apparatus (34) according to claim 10, wherein said displacement measurement sensors (36,37,38) are contacting sensors.

15. The apparatus (34) according to claim 14, wherein said contacting sensors are LVDTs.

16. The apparatus (34) according to claim 10, wherein said displacement measurement sensors (36,37,38) are non-contacting sensors.

17. The apparatus (34) according to claim 16, wherein said non-contacting sensors are laser ranging devices.

18. A system (20) for vibration testing of a printed circuit board (32) for use with a deflection measurement apparatus (34) during pre-testing operations, comprising:
a printed circuit board mounting structure (28) defining said reference mounting plane (49);
a device (50) for selectively supporting said printed circuit board (32) at one or more selected locations on a first surface of said printed circuit board (32) during said pre-testing operations; and
a vibrator unit (49) operatively coupled to said printed circuit board (32);
wherein said device (50) is operable to be moved between a supporting position during said pre-testing operations and a clearance position during vibration testing of said printed circuit board (32).

19. The system (20) according to claim 18, wherein said vibrator unit (49) is provided with a vibration controller (23), said device (50) is operatively coupled to a position sensor (112) generating a signal to said controller (23) for preventing operation of said vibrator unit (49) whenever said device (50) is moved to its supporting position.

20. (canceled)

21. (canceled)
